(19) United States
(12) Patent Application Publication
(10) Pub. No.: US 2017/0211788 A1
(43) Pub. Date: Jul. 27, 2017

(54) DRIVEWAY MARKER LIGHTS

(71) Applicants: Hugh Reid, Effort, PA (US); Sharon Shepard, Effort, PA (US)

(72) Inventors: Hugh Reid, Effort, PA (US); Sharon Shepard, Effort, PA (US)

(21) Appl. No.: 15/005,495

(22) Filed: Jan. 25, 2016

(51) Int. Cl. F21V 21/22; F21S 8/08; F21V 19/02; F21S 9/03; F21V 21/15

(52) U.S. Cl. CPC F21V 21/22; F21S 9/03; F21V 21/15; F21V 19/02; F21S 8/086; F21Y 2115/10

(57) ABSTRACT

A system and method for driveway marker light safety system mainly to assist the snowplow drivers during adverse weather conditions is disclosed. The lighting marker system comprises a set of telescoping tubes positioned on either side of the driveway wherein it has extending sections along with a light fixture placed on top of the apparatus. The system further comprises a photo eye detector for detecting the snow obstruction and adjusts the marker light section by using a gear drive or coiled plastic rod mechanism. A solar panel is provided in the apparatus for supporting the power supply.

### FIELD OF THE INVENTION

The present invention generally relates to driveway marker lights and more specifically relates to an automatic self-adjusting marker lights to assist motorists, vehicle drivers and snowplow drivers.

### BACKGROUND OF THE INVENTION

Snowfall during winter storm generally accumulates large amount of snow. During this time, the ground temperature goes as low as possible to allow precipitation. This can also happen in other seasons like late autumn and early spring bringing serious problems to the civic bodies. Especially highway roads during snow storm experience serious issues like safety of motorists, poor visibility, road closure, time and economic losses and so on. In order to avoid the aforementioned problems, significant number of steps has been taken and a snowplow device is one of that which removes ice and snow from outdoor surfaces and specifically used on winter servicing vehicles.

Snowplow devices exist in different configurations to efficiently remove snow from the driveway to reduce congestion for the drivers. However, during adverse weather conditions or any catastrophe, these snowplow drivers encounter a lot of problems to remove the snow due to huge accumulation of snow and poor visibility. During these times, the snowplow drivers face an uphill task to identify the edge of the road covered with snow. Many prior art technologies have attempted to solve these problems by having a safety lighting system on the device or other safety signboards. However, these systems have many additional limitations like power, electrical failure, icing problem and so on.

There are some lighting systems available in the prior art that are designed in such a way it can be controlled by a central system for various outdoor applications especially during adverse weather conditions including snowstorm. Ground based lighting system is used to provide proper illumination for the snowplow drivers but however, these systems do not provide more sustainability and efficiency during conditions like extreme and adverse weather, traffic congestion and so on.

One of the common limitations in the ground lighting safety system is the use of retraction of the marker lamp placed on the pole as it needs a separate mechanism like actuators for lifting and lowering the same. The lifting mechanism used in these inventions encounter a lot of problems from extreme weather conditions and it is prone to lose its efficiency. A separate power source is also needed to operate the system components. Additional cost and economic factor add to these limitations and eventually the efficiency of the entire unit is mitigated.

In light of aforementioned drawbacks and limitations, there exists a need for an improved driveway marker light safety system mainly to assist the snowplow drivers during adverse weather conditions.

### SUMMARY OF THE INVENTION

The present invention relates to a self-adjusting driveway marker light system that can be powered by a solar or any electric source.

According to the present invention, the driveway marker light will automatically adjust its height in different levels with regards to height of the snow covered in the area in order to assist the snowplow drivers to identify the boundary of the driveway clearly. The system includes telescoping tubes with teeth on it and a gear drive mechanism configure to actuate the telescoping tubes. The system also includes a photo eye sensor to detect the level of snow by which the gear in the drive mechanism turns and raises the telescoping tubes each level up along with the marker light unit.

### BRIEF DESCRIPTION OF DRAWINGS

FIG. 1 shows a perspective view of the self height adjustable lighting apparatus according to an embodiment of the present invention.

FIG. 2 shows a gear drive mechanism of the self height adjustable lighting apparatus according to an embodiment of the present invention.

FIG. 3 shows a coil drive mechanism of the self height adjustable lighting apparatus according to an embodiment of the present invention.

FIG. 4 shows a remote wireless control of the self height adjustable lighting apparatus according to an embodiment of the present invention.

### DETAILED DESCRIPTION OF THE INVENTION

The following detailed description of the different exemplary embodiments presents a description of certain specific embodiments to assist in understanding the claims. However, the present invention is intended to cover alternatives, modifications and equivalents, which may be included within the spirit and scope of the invention as defined by the appended claims.

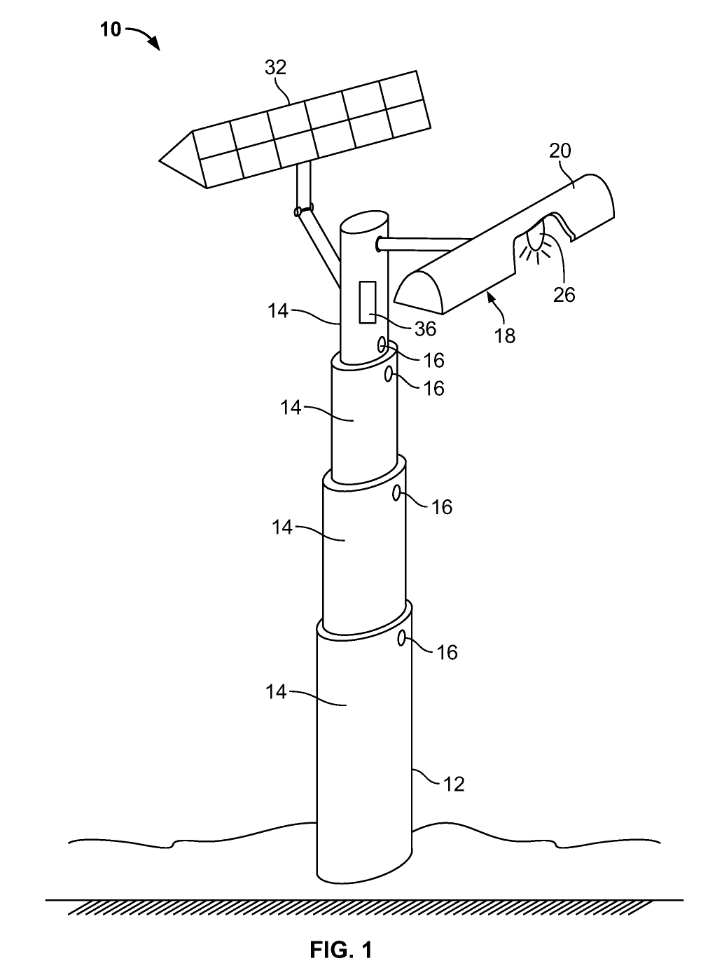

Referring to FIG. 1 in more detail, the reference numeral 10 generally designates a self height adjustable lighting apparatus embodying an aspect of the present invention. Self height adjustable lighting apparatus 10 comprises a base 12 and a plurality of telescoping tubes 14 each placed at a distance or interval of one foot. Several stages such as stage one, two, three and four of telescoping tubes 14 can be added to the base 12. Telescoping tubes 14 can be constructed of stainless steel or sturdy hollow plastic tubing material. A photo eye detector 16 is integrated with the telescoping tubes 14 to detect the obstruction i.e. snow level. Based on the detected snow level, the self height adjusting tube raises from foot level to next level. Light housing 20 is configured on the top of the self height adjustable lighting apparatus and it further comprises a swivel head 18 and this unit is adjustable using a supporting fixture fixed to telescoping tube 14 at angle of 90° and it points the edge of the driveway road. A screw is also provided to adjust swivel head 18 is present in the apparatus 10. A solar panel 32 with twenty four solar cells configured as twelve cells in the front and back side respectively is attached to the top section of the apparatus to receive solar energy. In a exemplary embodiment, the dimension of solar panel 32 is kept as 2×4 feet. Receiver 36 placed in the light assembly for receiving remote transmitting signals and adjusting the height of the telescoping tubes. The Light unit 26 comprising LEDs (light emitting diodes) emits light beam in a downward direction illumaniting the driveway

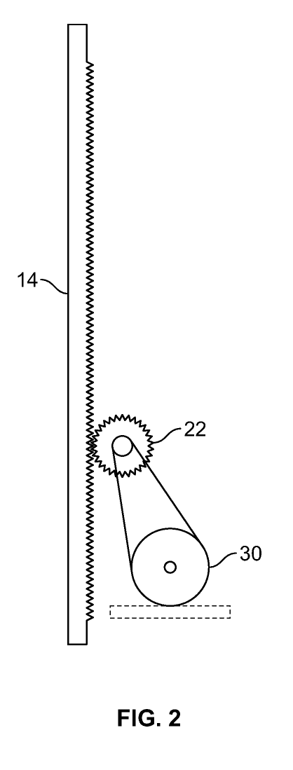

According to FIG. 1 which shows an in-ground application of self height adjustable lighting apparatus 10 comprising telescoping tubes 14 with a lower and upper portions. The photo eye detector 16 is configured to look at each other across the width of the driveway. For example, the photo eye detector 16 can be a photoelectric sensor or photo eye which is used to detect the distance of an object using a light transmitter. The configuration of photo eye detector 16 can differ in commercial and residential units. The light housing 20 can include hardware connections 24 that extend to multiple light units 26. Multiple light units 26 are shown, but it will be appreciated that a single light unit can operate in a stand-alone mode. For example, a photovoltaic cell or solar panel 32 According to FIG. 2, which illustrates working of gear drive mechanism in the self height adjusting apparatus. The height adjustment can be accomplished by drive mechanism 22. The teeth in the telescoping tubes 14 is configured to contact the gear drive to bring the tubing section to next higher level depending on the snow level. Gear drive assembly 22 can be operated by a motor 30. The motor 30 can comprise any suitable motive source, including electrical motors, solenoids, piston-and-cylinder units (pneumatic and hydraulic), etc. A gear drive mechanism 22 is provided in the apparatus for raising the telescoping tubes 14 each level up as photo eye detector detects the obstructing snow level.

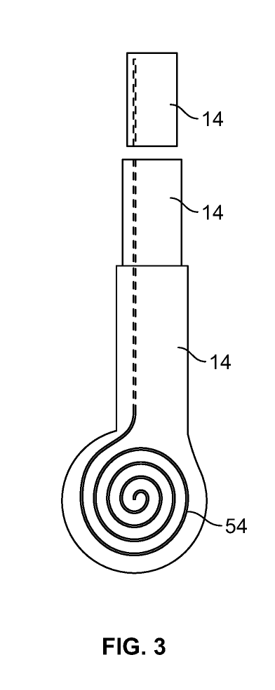

Another alternative embodiment of FIG. 3 describes about working mechanism of self height adjusting apparatus. A coil mechanism 54 comprising coiled plastic rod can be configured to push up various sections of telescopic tubes 14. The coiled plastic rod can be either flat or round tube.

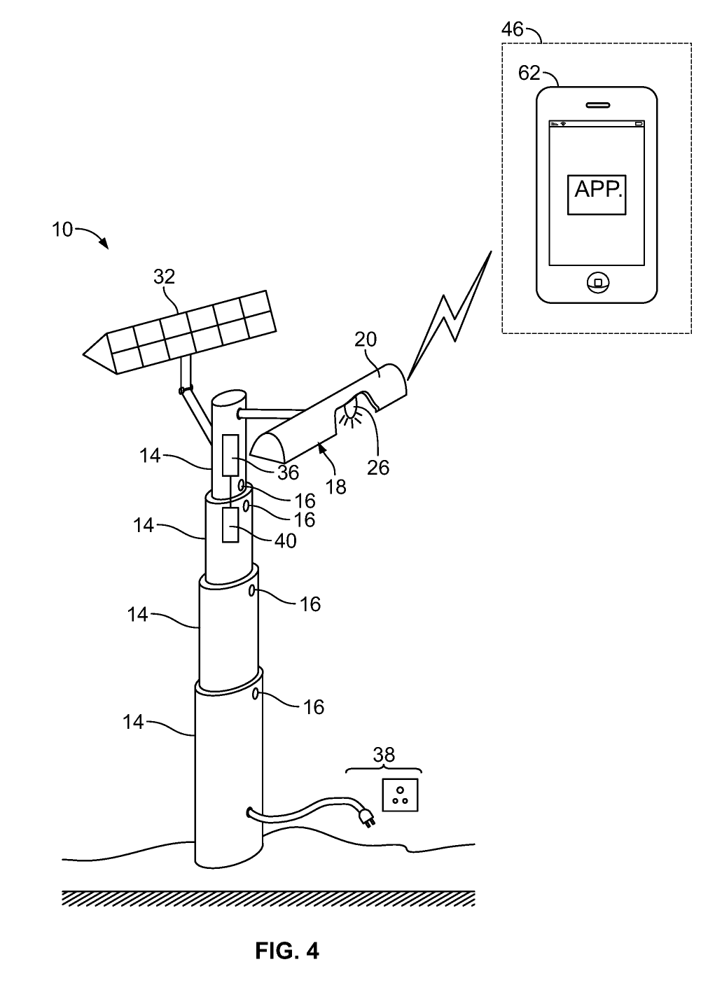

According to FIG. 4 describes the self height adjustable lighting apparatus 10 can receive control signals from a remote transmitter 46. A photo eye detector 16 in the self height adjustable lighting apparatus 10 can detect the snow fall level. For example, the photo eye detectors 16 can respond to surrounding light conditions and providing an appropriate light level indicating signal to the microprocessor. A light assembly 26 comprises a suitable light source, which can vary considerably depending upon the desired lighting effects. For example, incandescent and fluorescent light fixtures OR LEDs (light emitting diodes) can be utilized effectively, including applications with low voltage electrical power. The self height adjustable lighting apparatus 10 comprising photo eye detectors 16 detects snow level such that height of the telescoping tubes can be adjusted to next level. The light assembly 26 can be automatically activated, for extending the light to edge of the road through which user can visualize the drive way. Suitable devices can be utilized for such an automatic illumination function.

According to alternative embodiment of FIG. 4, describes the self height adjusting apparatus 10 comprising an alternative aspect or embodiment of the invention with a wireless remote controlling the height of the telescoping tubes 14. The height variation can be up to four feet for residential driveway units and chromed steel or plastic tubing tubular telescoping can be used. The main body section is one foot tall. The Light would be attached to the 3rd or top tube which can be four such that the top or 3rd tube is fully extended the unit will be four feet tall. On the commercial units the base section 12 is two feet tall with three telescoping two foot sections and can be eight feet tall fully deployed. Telescoping units 14 come back down, once the obstruction blocking the road is cleared when snow actually melts. A rechargeable battery 40 provides power supply whereby the self height adjustable lighting apparatus 10 can operate independently of external connections.

The photo eye detector 16 detects the rise of the snow fall and thereby the driver of the snowplow vehicle user can visualize the edge of the road easily. The passage of the radio waves over the antennas inside car or vehicle produces minute electrical charges. Depending on the length of the antenna design, differing frequencies of AM and FM bands to provide good reception. Based on the above configuration, mobile phone or smart phone or electronic devices 62 can wirelessly control the height of the self height adjusting apparatus.

The operation of self height adjusting apparatus 10 can be preprogrammed for a wide variety of light effects. The swivel head 18 can rotate or turn around to show the edge of roads for the user inside the vehicle or car. Remote transmitter 46 from the mobile device or Smartphone 62 transmits signal to the receiver 36 which in turn activates the gear drive mechanism or coil mechanism to raise the telescoping tubes 14 to the next level based on the snow accumulation. For example, extension and retraction of the telescoping tube 14 units can be timed for operation during predetermined hours of darkness. Photovoltaic or solar panel 32 can be provided for automatically charging in response to predetermined light levels during the day time. The light units 26 can be preprogrammed for sequential operation and various other operating sequences, including random operation.

According to another embodiment FIG. 4, the light assemblies 26 can utilize various lighting technologies in order to achieve desired operating and lighting effects. For example, incandescent, fluorescent, LED and other lighting technologies can be utilized. The light assemblies can comprise multiple individual lights, which in turn can have different characteristics such as color, intensity, directional orientation, etc. The individual lights within the light units 26 can also be individually controlled for sequencing and timing effects which provides the driveway for the vehicle user. The self height adjusting maker light 10 with a remote control 46 uses either solar 32 or electric power to clearly show the snow pile accumulation for the vehicle drivers.

Provided self height adjusting apparatus for detecting the occurrence of an amount of snowfall, or of drifting snow, above a predetermined level and providing a signal to the vehicle driver or user. The light source 26 is arranged to project a beam of light through the apertures in to a predetermined distance based on the snow fall detection of the photo eye detector 16. Upon interruption of the light beam by accumulated snow and detection of the snow level, the height of the telescoping tubes 14 should be adjusted automatically or the like to thereby indicate that a predetermined level of snowfall or drifted snow has occurred.

It is to be understood that the invention can be embodied in various forms, and is not to be limited to the examples discussed above. Other components and configurations can be utilized in the practice of the present invention.

1. A marker lighting device comprising;
at least pair of telescoping tubes configured to have teeth like indentations;
a gear drive motor mechanism associated with said telescoping tubes;
a renewable energy source to power the lighting device;
a height-adjustable light fixture positioned on top of the telescoping tubes;
a photo eye detector placed in the lighting device; and
a wireless remote communicating device to adjust height of the lighting fixture to provide assistance for snow plow drivers.

2. The marker lighting device according to claim 1, wherein said gear drive mechanism comprises a drive and electric motor connected to one of telescoping tubes and teeth like indentations in the telescoping tube to adjust the height of the light fixture.

3. The marker lighting device according to claim 1, wherein said lighting fixture placed on both sides of the driveway or road.

4. The marker lighting device according to claim 1, wherein lighting fixture have arm like structures placed at certain interval.

5. The marker lighting device according to claim 1, wherein lighting fixture includes an illuminating element.

6. The marker lighting device according to claim 1, wherein lighting fixture include two posts that are telescopically adjustable to move the lights vertically up or down with respect to the snow plow obstruction.

7. The marker lighting device of claim 6, wherein the housing is height adjustable.

8. A method of operating a marker lighting system, comprising the steps of:
a pair of telescoping tubes includes teeth like structures located in the lighting system;
a gear drive motor mechanism associated with said telescoping tubes for raising the lighting fixture level up at certain interval sensing or monitor a snow fall obstruction using a photo eye detector;
adjusting the height of the lighting fixture by gear drive motor mechanism positioned in telescoping tubes; and
a wireless remote communicating device to adjust height of the lighting fixture to provide assistance for snowplow drivers.

7. The method as defined in claim 8, wherein the substantial height of the lighting fixture is adjusted automatically.

8. The method as defined in claim 8, wherein the substantial height of the lighting fixture is adjusted using a swivel head portion.

9. The method as defined in claim 8, wherein the substantial height of the lighting fixture is adjusted automatically using power derived from solar panel or photovoltaic cell.

10. The method as defined in claim 8, wherein the substantial height of the lighting fixture is adjusted automatically uses power through electric motor.

11. The method as defined in claim 8, wherein the substantially height of the lighting fixture is adjusted automatically by the detection of photo eye detector.

12. The method as defined in claim 8, wherein the substantially height of the lighting fixture is adjusted automatically using remote wireless communication.
